(19) United States
(12) Patent Application Publication
(10) Pub. No.: US 2014/0055992 A1
(43) Pub. Date: Feb. 27, 2014

(54) ILLUMINATION MODULE AND APPARATUS AND ELEMENT THEREOF

(71) Applicant: LEXTAR ELECTONICS CORPORATION, Hsinchu (TW)

(72) Inventor: Han-Chung Hsu, Luzhu Township (TW)

(73) Assignee: LEXTAR ELECTRONICS CORPORATION, Hsinchu (TW)

(21) Appl. No.: 13/721,843

(22) Filed: Dec. 20, 2012

(30) Foreign Application Priority Data
Aug. 23, 2012 (TW) 101130669

(51) Int. Cl. F21V 5/00

(52) U.S. Cl. CPC F21V 5/008
USPC 362/235; 362/334; 362/268

(57) ABSTRACT

An illumination apparatus includes an optical element. The optical element includes a light incident curved surface and a light outgoing curved surface. The center of curvature of the light incident curved surface is positioned on the center of the light emitting surface of a light source, and the center of the curvature of the light outgoing curved surface is positioned beneath the center of curvature of the light incident curved surface and deviates from the light source. The radius of curvature R1 of the light outgoing curved surface is greater than the radius of curvature R2 of the light incident curved surface.

### RELATED APPLICATIONS

This application claims priority to Taiwan Application Serial Number 101130669, filed Aug. 23, 2012, which is herein incorporated by reference.

### BACKGROUND

1. Technical Field

Embodiments of the present invention relate to an illumination apparatus. More particularly, embodiments of the present invention relate to an illumination apparatus, an illumination module and an optical diffuser thereof.

2. Description of Related Art

In recent years, eco-friendly products have been the main stream in the market. Concerning the products for illumination, in order to save energy, the light emitting diode (LED), which has many advantages such as low power consumption and high efficiency, is widely applied in the illumination device. In the illumination device, the LED can be used to replace the incandescent light bulb and the fluorescent lamp. A LED lamp tube generally includes a light bar and a lampshade. The LEDs are mounted on the light bar, and the lampshade covers the light bar for protecting the LEDs.

However, the light emission angle of the LED is about 120 degrees, in which the illuminance beyond the light emission angle is seriously lower than that within the light emission angle, causing non-uniform illuminance. Under such circumstance, in case of the LED lamp tube installed on the ceiling, there is only a small part of the light illuminating the ceiling, such that the ceiling with lower illuminance is apt to make human eye uncomfortable.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

One aspect of the present invention provides an optical diffuser, and this optical diffuser can be used to increase the emitting area or range of the light source, so as to make the illuminance of different areas more uniform. In accordance with one embodiment of the present invention, the optical diffuser includes a light incident curved surface and a light outgoing curved surface. The center of curvature of the light incident curved surface is positioned on the center of a light emitting surface of a light source. The center of the curvature of the light outgoing curved surface is positioned beneath the center of curvature of the light incident curved surface and deviates from the light source. The radius of curvature R1 of the light outgoing curved surface is greater than the radius of curvature R2 of the light incident curved surface.

Another aspect of the present invention provides an illumination module. In accordance with one embodiment of the present invention, the illumination module employs the LED as the light source, and further employs the foregoing optical diffuser to increase the emitting range of the LED, so as to make the illuminance of different areas more uniform.

Yet another aspect of the present invention provides an illumination apparatus. In accordance with one embodiment of the present invention, the illumination apparatus includes a tube, a substrate, at least one light source and an optical diffuser. The tube includes a lampshade and a heat dissipation base. The lampshade and the heat dissipation base form a lamp chamber. The substrate is contained in the lamp chamber. The light source is disposed on the substrate. The optical diffuser is contained in the lamp chamber to increase the emitting range of the light source, so as to make the illuminance of different areas more uniform.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a side view of an optical diffuser in accordance with one embodiment of the present invention;

FIG. 2 is a light path diagram of the optical diffuser of FIG. 1;

FIG. 3A and FIG. 3B are respectively a top view and a perspective view of an illumination apparatus in accordance with one embodiment of the present invention;

FIG. 4 is an explosive view of the illumination apparatus of FIG. 3A and FIG. 3B;

FIG. 5 is a cross-sectional view of the illumination apparatus of FIG. 3A along A-A line;

FIG. 6 is a partially cross-sectional view of the illumination apparatus of FIG. 5;

FIG. 7 is a luminous intensity distribution diagram of the illumination apparatus of FIG. 4.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

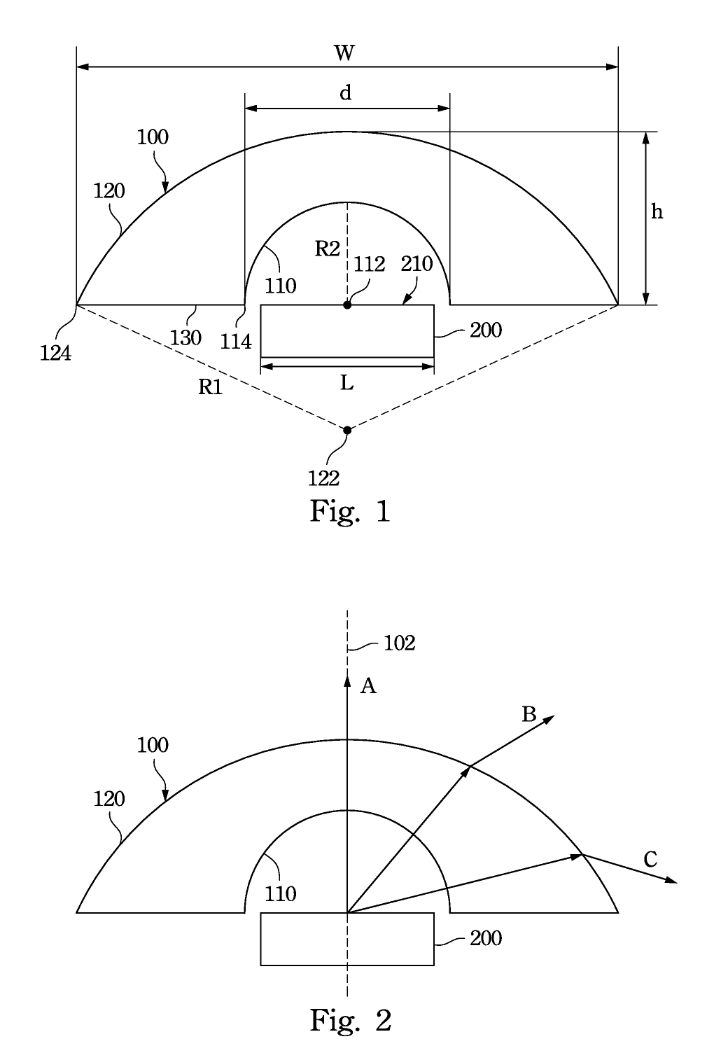

FIG. 1 is a side view of an optical diffuser in accordance with one embodiment of the present invention. As shown in FIG. 1, the optical diffuser 100 includes a light incident curved surface 110 and a light outgoing curved surface 120. The center of curvature 112 of the light incident curved surface 110 is positioned on the center of a light emitting surface 210 of a light source 200. The center of the curvature 122 of the light outgoing curved surface 120 is positioned beneath the center of curvature 112 of the light incident curved surface 110 and deviates from the light source 200. The radius of curvature R1 of the light outgoing curved surface 120 is greater than the radius of curvature R2 of the light incident curved surface 110.

FIG. 2 is a light path diagram of the optical diffuser 100 of FIG. 1. As shown in FIG. 2, when light source 200 emits a light beam A, the light beam A is not refracted because the light beam A propagates along the optical axis 102 of the optical diffuser 100. In other words, the light beam A orthogonally passes through the light incident curved surface 110 and the light outgoing curved surface 120, and it is consequently not refracted. When the light source 200 emits a light beam B, the light beam B deviates from the optical axis 102. In other words, the light beam B orthogonally passes through the light incident curved surface 110 while obliquely passes through the light outgoing curved surface 120. Because the radius of curvature R1 of the light outgoing curved surface 120 is greater than the radius of curvature R2 of the light incident curved surface 110, the curvature of the light outgoing surface 120 is lower than the curvature of the light incident curved surface 110, and therefore, the light beam B is refracted and directed outwardly at the light outgoing curved surface 120. Similarly, when the light source 200 emits a light beam C, the light beam C also deviates from the optical axis 102. In other words, the light beam C orthogonally passes through the light incident curved surface 110 while obliquely passes through the light outgoing curved surface 120. Because the light beam B and the light beam C are directed outwardly when passing through the light outgoing curved surface 120, the emitting range of the light source 200 can be increased, so that the illuminance of different areas is more uniform.

It is noted that the term “orthogonally passes” refers that the light beam perpendicularly passes through an interface without refraction.

Further, as shown in FIG. 2, when the light beams emitted by the light source 200 deviates farer away from the optical axis 102, the refraction angle is higher. In other words, the higher the angle included between the light beam emitted by the light source 200 and the optical axis is, the higher the refraction angle at the light outgoing curved surface 120 will be.

Referring back to FIG. 1, in some embodiments, the chord length W of the light outgoing curved surface 120 is greater than the chord height of the light outgoing curved surface 120. In other words, the width of the optical diffuser 100 is greater than the height thereof. Therefore, the light outgoing curved surface 120 is a flat arc-shaped surface, so as to refract the light beams emitted by the light source 200 outwardly, thereby increasing the emitting range.

In some embodiments, the chord length W and the chord height h of the light outgoing curved surface 120 are greater than the diameter of curvature d of the light incident curved surface 110. In other words, the size of the light outgoing curved surface 120 is greater than the light incident curved surface 110 and is positioned beyond the light incident curved surface 110, so that the light beams emitted by the light source 200 passes through the light incident curved surface 110 prior than passing through the light outgoing curved surface 120. Preferably, the chord length W of the light outgoing curved surface 120 ranges from about twice to 4 times the diameter of curvature d of the light incident curved surface 110. The chord height h of the light outgoing curved surface 120 ranges from about 1.25 times to twice of the diameter of curvature d of the light incident curved surface 110.

In some embodiments, the diameter of curvature d of the light incident curved surface 110 is not less than the length L of the light source 200. In other words, the light incident curved surface 110 is wider than the light source 200 for ensuring all light beams emitted by the light source 200 can pass through the light incident curved surface 110 and gets into the optical diffuser 100. Preferably, the diameter of curvature d of the light incident curved surface 110 is greater than 1.1 times the length L of the light source 200.

In some embodiments, the light incident curved surface 110 is a hemispherical surface. Because the center of curvature 112 of the light incident curved surface 110 is positioned on the center of the light emitting surface 210 of the light source 200, all the light beams emitted by the light source 200 along various directions can orthogonally pass through the light incident curved surface 110.

In some embodiments, the rim 124 of the light outgoing curved surface 120 is at the same height as that of the rim 114 of the light incident curved surface 110. The optical diffuser 100 includes a bottom surface 130, which is formed between the rim 124 of the light outgoing curved surface 120 and the rim 114 of the light incident curved surface 110. Because the rim 124 and the rim 114 are at the same height, the bottom surface 130 of the optical diffuser 100 is parallel to the light emitting surface 210.

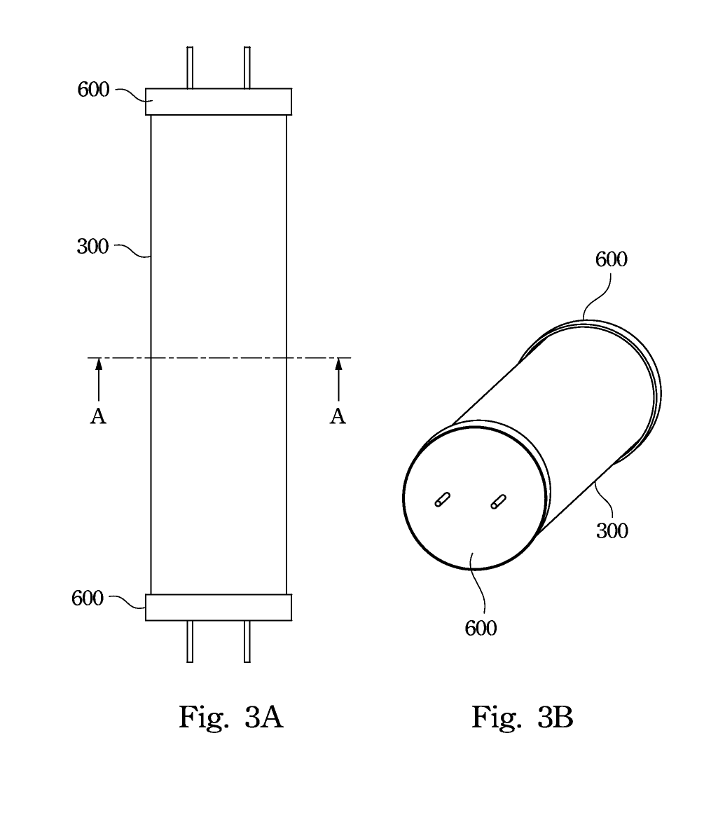

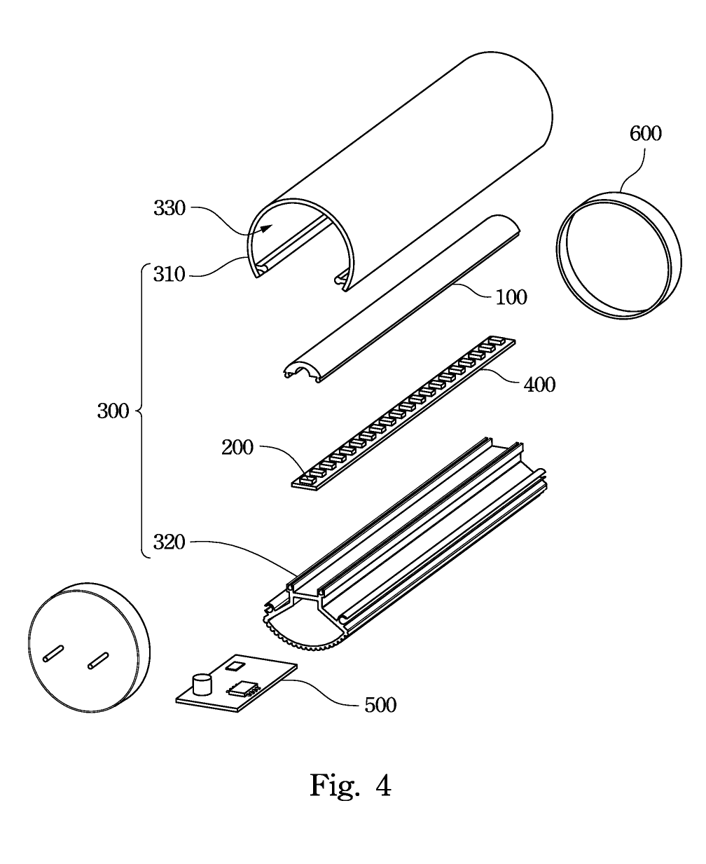

FIG. 3A and FIG. 3B are respectively a top view and a perspective view of an illumination apparatus in accordance with one embodiment of the present invention. FIG. 4 is an explosive view of the illumination apparatus of FIG. 3A and FIG. 3B. As shown in FIGS. 3A, 3B, and 4, the illumination apparatus includes a tube 300, a substrate 400, at least one light source 200 and an optical diffuser 100. The tube 300 includes a lampshade 310 and a heat dissipation base 320. The lampshade 310 and the heat dissipation base 320 form a lamp chamber 330. The substrate 400 is contained in the lamp chamber 330. The light source 200 is disposed on the substrate 400. The optical diffuser 100 is contained in the lamp chamber 330 to increase the emitting range of the light source 200, so as to make the illuminance of different areas more uniform. The optical diffuser 100 is shown as FIG. 1 and FIG. 2 and the related description mentioned above, and therefore, it is not described redundantly herein.

In some embodiments, the number of the at least one light source 200 is plural, and the light sources 200 are arranged on the substrate 400 along the lengthwise direction of the tube 300, and the optical diffuser 100 extends along the direction that the light sources 200 are arranged. Specifically, the tube 300 is a circular tube, and the substrate 400 is a rectangular plate parallel to the lengthwise direction of the tube 300. The light sources 200 are arranged along the lengthwise direction of the rectangular plate.

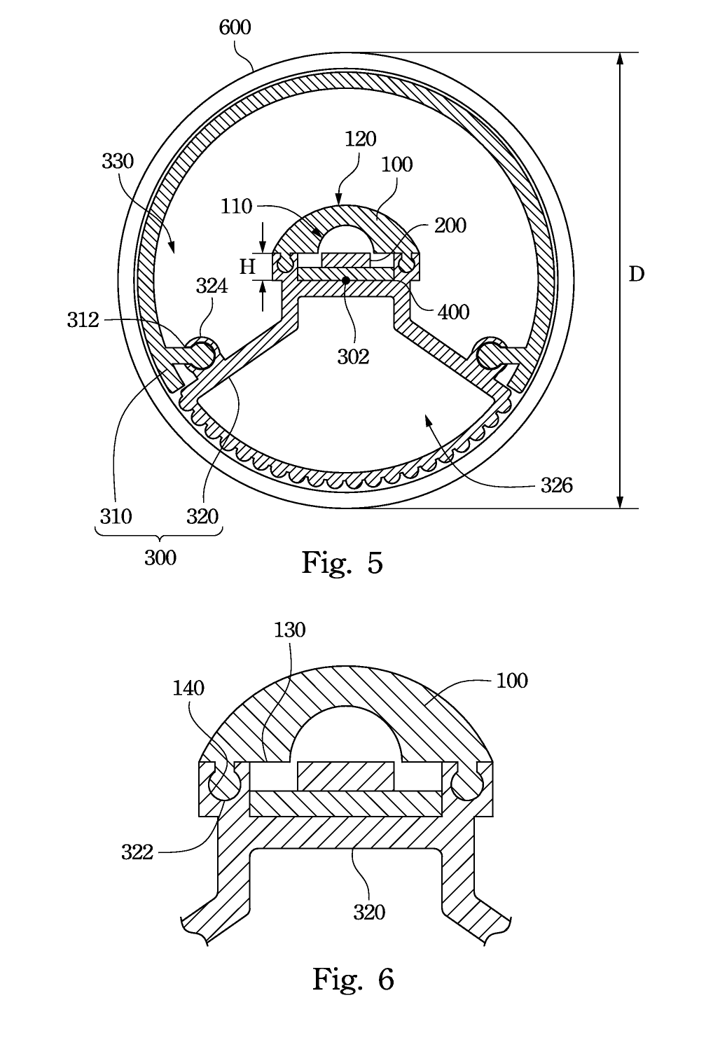

FIG. 5 is a cross-sectional view of the illumination apparatus of FIG. 3A along A-A line. As shown in FIG. 5, in this embodiment, the substrate 400 and the optical diffuser 100 are disposed on the heat dissipation base 320.

The opposite surfaces of the substrate 400 respectively contacts the light source 200 and the heat dissipation base 320, so the thermal energy generated by the light source 200 is transferred to the heat dissipation base 320 via the substrate 400 by thermal conduction, and then, the heat dissipation base 320 dissipates the thermal energy to the environment.

The optical diffuser 100 is positioned on the heat dissipation base 320 and covers the light source 200. In other words, the optical diffuser 100 is positioned above the light emitting surfaces 210 of the light sources 200, so as to enable the light beams emitted from the light emitting surfaces 210 of the light sources 200 passing through the light incident curved surface 110 and the light outgoing curved surface 120 of the optical diffuser 100. The light path passing through the optical diffuser 100 refers to FIG. 2 and the related description mentioned above.

FIG. 6 is a partially cross-sectional view of the illumination apparatus of FIG. 5. As shown in FIG. 5, in some embodiments, the optical diffuser 100 further includes a pair of fastening elements 140, and the heat dissipation base 320 includes a pair of fastening grooves 322. The fastening elements 140 respectively insert into the fastening grooves 322. Specifically, the fastening elements 140 are protruded on the bottom surface 130 of the optical diffuser 100, and the fastening grooves 322 are recessed on the surface of the heat dissipation base 320, in which the surface is used for placing the optical diffuser 100. The fastening elements 140 and the fastening grooves 322 match in shape. In other words, the shape and size of the fastening elements 140 and the fastening grooves 322 are substantially identical. Therefore, the fastening elements 140 can insert into the fastening grooves 322 along the lengthwise direction of the tube 300 for fastening the optical diffuser 100 on the heat dissipation base 320 and preventing the optical diffuser 100 from moving freely. In some embodiments, the fastening element 140 is a cylinder, and the fastening groove 322 is a circular groove with equal size.

Referring back to FIG. 5, in some embodiments, the lampshade 310 includes a pair of rails 312, and the heat dissipation base 320 includes a pair of railing grooves 324, and the rails 312 are respectively assembled in the railing grooves 324. Specifically, the rails 312 are protruded on the inner surface of the lampshade 310, and the railing grooves 324 are formed on the lateral walls of the heat dissipation base 320. The rails 312 and the railing grooves 324 match in shape. In other words, the shape and size of the rails 312 and the railing grooves 324 are substantially identical. Therefore, the rails 312 can insert into the railing grooves 324 along the lengthwise direction of the tube 300, so as to fasten the lampshade 310 on the heat dissipation base 320 and thereby constituting the tube 300. In some embodiments, the rail 312 is a cylinder, and the railing groove 324 is a circular groove with equal size.

In some embodiments, the distance H between the light emitting surface 210 (See FIG. 1) of the light source 200 and the central axis 302 of the tube 300 is less than ¼ times the diameter D of the tube 300. Specifically, the light source 200 deviates from the central axis 302 of the tube 300. For example, the light source 200 is positioned above the central axis 302 and the distance H is less than ¼ D. Alternatively, the light source 200 can also be positioned beneath the central axis 302 and the distance H is less than ¼ D. The position of the light source 200 can be altered by modifying the shape of the heat dissipation base 320.

In some embodiments, the heat dissipation base 320 comprises a cavity 326. In other words, the heat dissipation base 320 is a hollow structure. Referring to FIG. 4 and FIG. 5, in some embodiments, the illumination apparatus further includes a driver board 500 contained in the cavity 326. The driver board 500 can be electrically connected to the light source 200 to drive it.

Referring to FIG. 4, in some embodiments, the illumination apparatus further includes two end caps 600 covering opposite ends of the tube 300, so as to form a sealed space in the tube 300, thereby preventing dusts or water from getting into the tube 300. Specifically, the end caps 600 match the ends of the tube 300. In other words, the size and shape of the end cap 600 and the tube 300 are substantially identical, so that the end caps 600 can stably cover the ends of the tube 300. For example, the cross section of the tube 300 and the end cap 600 can be circular or elliptical in similar size and shape.

In some embodiments, the lampshade 310 and the optical diffuser 100 can be formed by the light transmissive material such as, for example, Polymethylmethacrylate (PMMA, or named Acrylic). But the material is not limited to PMMA.

In some embodiments, the light source 200 is a LED. The LED can be, but is not limited to be, a LED package or a LED chip. The LED can be, but is not limited to be, a white LED, a red LED, a green LED, or a blue LED.

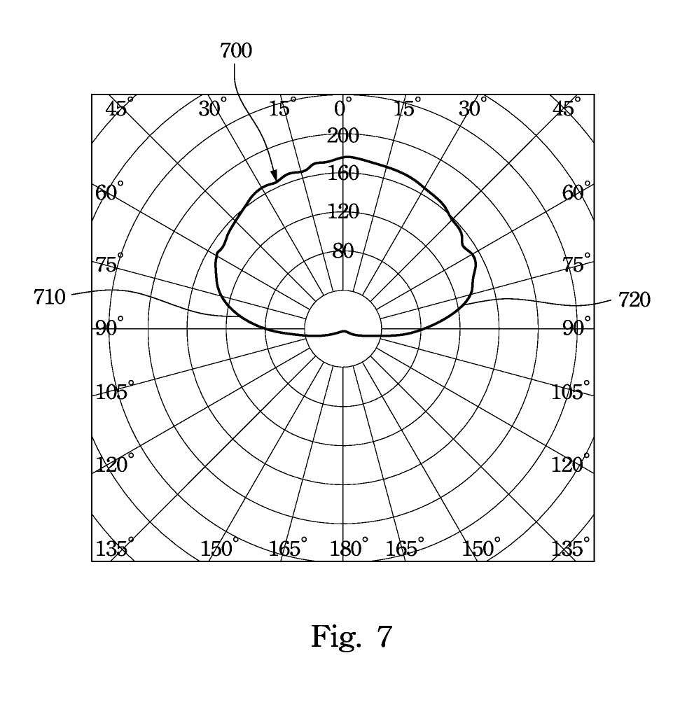

FIG. 7 is a luminous intensity distribution diagram of the illumination apparatus of FIG. 4. As shown in FIG. 7, the emitting range of the illumination apparatus is shown as the area 700, in which the angle difference between the left curve 710 and the right curve 720 reaches about 200 degrees, notably increasing the emitting range and the emitting angle, thereby implementing an effect of wide-angle. It is noted that the emitting range refers that the area covered by half of the maximal light intensity of the light beams emitted by the light source 200.

In accordance with another embodiment of the present invention, an illumination module is disclosed, which includes a light source 200 and an optical diffuser 100. The light source 200 is a LED, and the optical diffuser 100 is positioned above the LED to increase the emitting range of the LED, so as to make the illuminance of different areas more uniform.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An optical diffuser, comprising:
a light incident curved surface; and
a light outgoing curved surface, wherein the center of curvature of the light incident curved surface is positioned on the center of a light emitting surface of a light source, wherein the center of curvature of the light outgoing curved surface is positioned beneath the center of curvature of the light incident curved surface and deviates from the light source, wherein the radius of curvature R1 of the light outgoing curved surface is greater than the radius of curvature R2 of the light incident curved surface.

2. The optical diffuser of claim 1, wherein the chord length of the light outgoing curved surface is greater than the chord height of the light outgoing curved surface.

3. The optical diffuser of claim 2, wherein the chord length and the chord height of the light outgoing curved surface is greater than the diameter of curvature of the light incident curved surface.

4. The optical diffuser of claim 3, wherein the chord length of the light outgoing curved surface ranges from about twice to 4 times the diameter of curvature of the light incident curved surface.

5. The optical diffuser of claim 3, wherein the chord height of the light outgoing curved surface ranges from about 1.25 times to twice of the diameter of curvature of the light incident curved surface.

6. The optical diffuser of claim 3, wherein the diameter of curvature of the light incident curved surface is not less than the length of the light source.

7. The optical diffuser of claim 6, wherein the diameter of curvature of the light incident curved surface is greater than 1.1 times the length of the light source.

8. The optical diffuser of claim 1, wherein the light incident curved surface is a hemispherical surface.

9. The optical diffuser of claim 8, wherein the rim of the light outgoing curved surface is at the same height as that of the rim of the light incident curved surface.

10. A illumination module, comprising:
a LED (light emitting diode); and
an optical diffuser comprising:
a light incident curved surface; and
a light outgoing curved surface, wherein the center of curvature of the light incident curved surface is positioned on the center of a light emitting surface of the LED, wherein the center of curvature of the light outgoing curved surface is positioned beneath the center of curvature of the light incident curved surface and deviates from the LED, wherein the radius of curvature R1 of the light outgoing curved surface is greater than the radius of curvature R2 of the light incident curved surface.

11. An Illumination apparatus, comprising:
a tube having a lampshade and a heat dissipation base, the lampshade and the heat dissipation base form a lamp chamber;
a substrate contained in the lamp chamber;
at least one light source disposed on the substrate; and
an optical diffuser contained in the lamp chamber, the optical diffuser comprising:
a light incident curved surface; and
a light outgoing curved surface, wherein the center of curvature of the light incident curved surface is positioned on the center of a light emitting surface of the light source, wherein the center of the curvature of the light outgoing curved surface is positioned beneath the center of curvature of the light incident curved surface and deviates from the light source, wherein the radius of curvature R1 of the light outgoing curved surface is greater than the radius of curvature R2 of the light incident curved surface.

12. The illumination apparatus of claim 11, wherein the substrate and the optical diffuser are disposed on the heat dissipation base.

13. The illumination apparatus of claim 12, wherein the number of the at least one light source is plural, and the light sources are arranged on the substrate along the lengthwise direction of the tube, and the optical diffuser extends along the direction that the light sources are arranged.

14. The illumination apparatus of claim 13, wherein the optical diffuser is positioned above the light emitting surfaces of the light sources.

15. The illumination apparatus of claim 12, wherein the optical diffuser further comprises a pair of fastening elements, and the heat dissipation base comprises a pair of fastening grooves, and the fastening elements respectively insert into the fastening grooves.

16. The illumination apparatus of claim 11, wherein the lampshade comprises a pair of rails, and the heat dissipation base comprises a pair of railing grooves, and the rails are respectively assembled in the railing grooves.

17. The illumination apparatus of claim 11, wherein the distance between the light emitting surface of the light source and the central axis of the tube is less than ¼ times the diameter of the tube.

18. The illumination apparatus of claim 17, wherein the light source deviates from the central axis of the tube.

19. The illumination apparatus of claim 11, wherein the heat dissipation base comprises a cavity.

20. The illumination apparatus of claim 19, further comprising a driver board contained in the cavity.

21. The illumination apparatus of claim 11, further comprising two end caps covering opposite ends of the tube.

22. The illumination apparatus of claim 11, wherein the chord length of the light outgoing curved surface is greater than the chord height of the light outgoing curved surface.

23. The illumination apparatus of claim 22, wherein the chord length and the chord height of the light outgoing curved surface is greater than the diameter of curvature of the light incident curved surface.

24. The illumination apparatus of claim 23, wherein the chord length of the light outgoing curved surface ranges from about twice to 4 times the diameter of curvature of the light incident curved surface.

25. The illumination apparatus of claim 24, wherein the chord height of the light outgoing curved surface ranges from about 1.25 times to twice of the diameter of curvature of the light incident curved surface.

26. The illumination apparatus of claim 23, wherein the diameter of curvature of the light incident curved surface is not less than the length of the light source.

27. The illumination apparatus of claim 26, wherein the diameter of curvature of the light incident curved surface is greater than 1.1 times the length of the light source.

28. The illumination apparatus of claim 11, wherein the light incident curved surface is a hemispherical surface.

29. The illumination apparatus of claim 28, wherein the rim of the light outgoing curved surface is at as the same height as that of the rim of the light incident curved surface.

30. The illumination apparatus of claim 11, wherein the light source is a LED.
